(19) United States
(12) Patent Application Publication
(10) Pub. No.: US 2009/0072043 A1
(43) Pub. Date: Mar. 19, 2009

(54) NOZZLE FOR GENERATING HIGH-ENERGY CAVITATION

(76) Inventors: Ilia KONDRATAYEV, Gainesville, FL (US); John Fulkerson, Gainesville, FL (US); Igor Kamenkov, Simferpol (UA); Vladimir A. Paramygin, Gainesville, FL (US)

Correspondence Address: BROWDY AND NEIMARK, P.L.L.C.;624 NINTH STREET, NW, SUITE 300, WASHINGTON, DC, 20001-5303, US

(21) Appl. No.: 12/191,782

(22) Filed: Aug. 14, 2008

Related U.S. Application Data
(62) Division of application No. 11/006,811, filed on Dec. 8, 2004.

(51) Int. Cl. B05B 17/04

(52) U.S. Cl. 239/11

(57) ABSTRACT

A cavitation nozzle includes a hydro-acoustic oscillator, an orifice, and a conical diffuser. The conical diffuser includes a first zone for diffusing a liquid jet, a second zone comprising two or more shear chambers for creating additional cavitation bubbles by creating rotational flow in the chamber, and a third zone which has a diameter larger than the shear chambers or the first zone.

### FIELD OF THE INVENTION

The present invention relates to a nozzle for inducing hydrosonic cavitation in liquids and for methods of generating surface energy using this nozzle.

### BACKGROUND OF THE INVENTION

The boiling points of liquids depend on the pressure of the liquid. The boiling temperature drops with decreasing pressure. Under a strong vacuum, such as may occur at high velocities, or when the ambient pressure drops, pressure can locally decrease so that a liquid boils. Such conditions frequently occur in hydrodynamic flow machines, such as pumps, turbines, propellers, for instance, or when turbine blades are passed, etc. This results in what is known as cavitation. In cavitation, vacuum, vapor and gas bubbles are created in a liquid, and these bubbles cause the formation of voids. A subsequent pressure rise is accompanied by rapid collapse of the bubbles, so-called impact condensation.

Although cavitation is in many cases undesirable because of the possibility of erosion of the material around which the flow occurs, as well as the considerable noise caused by cavitation, cavitation may be usefully applied in other instances, such as an aid in destroying microorganisms in waste water.

In cavitation, a certain amount of ultrasonic energy is introduced into a liquid. However, conventional means for generating cavitation by means of ultrasonic energy involves complex equipment. Another method for generating cavitation is by means of a cavitator, which is substantially similar to a centrifuge, but this is also relatively complex and expensive. Also known are cavitation generators that use vibrating pistons (magnetorestriction) to generate ultrasound waves.

The surface energy of a liquid can be increased by increasing the surface area between the liquid and the fluid which the liquid encloses, e.g., air. Therefore it is desirable to create larger amounts of smaller bubbles to maximize the total surface area of all bubbles. Part of the potential energy released from the bubbles' collapsing is transformed into heat energy. Another feature of collapsing bubbles is generation of a mechanical force. A cavitation bubble has a very low pressure, so at the time it collapses it creates a very strong force on the medium into which it collapses.

High velocity jets are used, for example, in air or liquid environments for cutting soil in dredging operations, as well as for cutting and moving materials such as in mining.

Modern cleaning systems often use a fluid jet to remove rust, scale, or coatings from a surface to be cleaned. Typically, these surfaces are cleaned by the application of a fluid which carries an abrasive substance, such as sand, particularly when it is desired to clean a corroded or coated metal surface down to bare metal. In many prior art systems, use of a high-pressure fluid without an abrasive would not effectively clean the surface.

It is known in the art to use cavitation to increase the cleaning power of a fluid jet. Essentially, the principle of cavitation involves lowering the pressure of a fluid to below its vapor pressure. As the fluid reaches pressures below its vapor pressure, bubbles of vaporized fluid form in the jet. As the jet contacts a surface to be cleaned, these bubbles collapse and release kinetic energy. This energy can be used to remove rust, scale, or other coating. The rust, scale or other coating is removed because when the cavitation bubbles collapse, the fluid into which the bubbles collapse is subjected to great forces, so that the fluid is able to tear particles off of the surface that are contacted by these bubbles.

Cavitation nozzles have also been used for water remediation and purification. In a similar manner, cavitation can be used to destroy microorganisms in a fluid or on a surface. In this case, a stream of wastewater is pumped through a cavitation nozzle, ionizing the water, which oxidizes the contaminants.

U.S. Pat. No. 6,221,260 to Chahine et al., discloses a swirling fluid jet cavitation method for efficient decontamination of liquids. The process entails the use of a jet nozzle having a swirl chamber disposed therein. The swirl chamber moves liquid about a longitudinal axis, creating a central vortex in which the core pressure of the vortex is less than the vapor pressure of the liquid. This induces cavitation pockets in the liquid, which, in turn, causes decomposition of contaminants in the liquid. The diameter of the inlet orifice of the swirl chamber is less than that of the exit orifice.

Ivannikov et al., in U.S. Published Application No. US 2003/0047622, provide for a cavitating jet for deep borehole drilling. The jet comprises a body with profile flow channel and a flow-obstructing barrier movable in a radial direction. The barrier, which may be a ball or cylinder, induces separation of the cavitational cavities formed as liquid flows around said barrier.

U.S. Published Application No. US 2004/0011522 to Ivvanikov et al. discloses a device for performing hydrodynamic action on wellbore walls. The device comprises in part an auto-oscillating system for cavitating a liquid. Specifically, the system includes a ball of slightly smaller diameter than a surrounding casing, as well as a coil or other device, to limit the axial movement of said ball. Alternatively, the cavitating device may include a cone, the nose of which is directed to counter fluid flow, and where the cone is placed in a diffuser providing a clearance to permit some flow of liquid and some axial movement of the cone. In another embodiment, the cavitation mechanism may comprise a butterfly valve freely rotating around a transverse shaft.

Folts et al., in U.S. Pat. No. 5,125,425, provide for a cleaning and deburring nozzle comprised of a nozzle with lateral slots for discharging a high pressure liquid. The nozzle includes a constriction orifice between an enlarged or main orifice. Additionally, a restriction orifice leads to the slots, the restriction orifice increasing the velocity of the liquid issuing from the slots. The nozzle is particularly suited to deburring transmission fluid channels.

Problems exist with prior art nozzles that are used to produce cavitation because, for the nozzle to produce substantial cavitation bubbles, the fluid passing through the nozzle had to be under much higher pressure than can be achieved with conventional nozzles.

### SUMMARY OF THE INVENTION

It is an object of the present invention to overcome the deficiencies in the prior art.

It is another object of the present invention to provide a cavitation nozzle for use in a liquid medium.

It is a further object of the present invention to provide a cavitation nozzle that can be used for cleaning surfaces.

It is still another object of the present invention to provide a cavitation nozzle for demolition and/or stripping coatings from surfaces.

It is yet another object of the present invention to provide a cavitation nozzle that can be used to disinfect liquids.

It is still another object of the present invention to provide a cavitation nozzle that can be used to remediate contaminated liquids.

The cavitation nozzle of the present invention comprises a hydro-acoustic oscillator, an orifice, and a conical diffuser with one or more “shear chambers.”

### BRIEF DESCRIPTION OF THE DRAWINGS

FIGS. 1a-c are side views of cavitation nozzles.

FIG. 2 is a side section view of the nozzle of the present invention.

FIG. 3 shows the relationship between nozzle diameter and pressure.

### DETAILED DESCRIPTION OF THE INVENTION

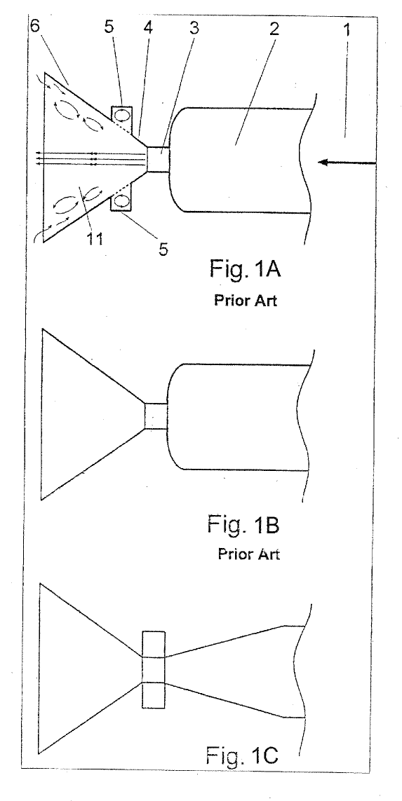

FIG. 1a is a side section view of the cavitation nozzle 10 of the present invention. The nozzle comprises a hydro-acoustic oscillator 2, an orifice 3, and a conical diffuser 11 with one or more “shear chambers” 5. While FIG. 1a shows one shear chamber on each side of the diffuser, it is possible to have more than one shear chamber on each side to introduce additional reverse flow.

In use, liquid is supplied from a source 1 into the hydro-acoustic oscillator 2, which is connected to the orifice 3, which in turn is connected to the diffuser 11. The hydro-acoustic oscillator 2 introduces pressure fluctuation (dynamic pressure) into the liquid to stimulate cavitation generation. The liquid then flows through the orifice 3, which has a significantly smaller diameter than the water source or hydro-acoustic oscillator, which causes the velocity of the flow of liquid to dramatically increase, creating low-pressure conditions which favor production of cavitation bubbles. Preferably, the diameter of the hydro-acoustic oscillator 2 is at least three times the diameter of the orifice 3. More preferably, the diameter of the hydro-acoustic oscillator is at least four to six times greater than the diameter of the orifice 3.

The fluid is then injected into the diffuser 11 which comprises three zones. The first zone, 4 serves to diffuse the liquid jet. The second zone 5 comprises shear chambers which create additional cavitation bubbles by creating a rotational (vortical) flow in the chambers. In the case of vortical flow, the center of the vortex is the point of extremely low pressure where the cavitation bubbles are created. The third zone 6 of the diffuser 11 employs similar principles as in the shear chambers 5 to generate cavitation bubbles. However, in the third zone 6, vortices are created because of the shear stresses between the jet flow and ambient fluid into which the jet is introduced. The jet has a very high speed, and it also creates a zone of low pressure. The pressure in this low-pressure zone is lower than the pressure of the ambient fluid into which the jet is injected, and that causes flow in the direction from high to low pressure. This further increases shear stress because fluid is now flowing into opposite directions, as shown in FIG. 1a, which increases the cavitation effect.

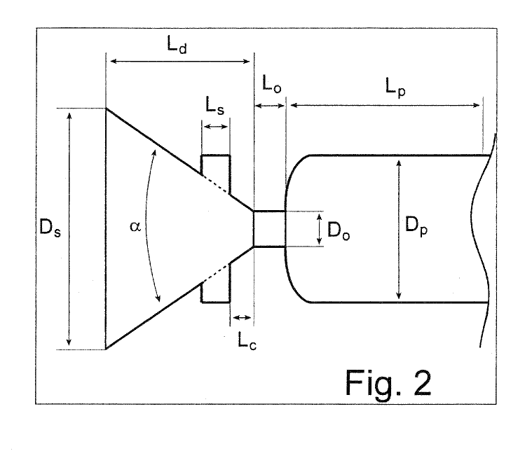

FIG. 2 shows a side section view of the nozzle 10, and outlines important dimensional parameters. The length and diameter of the hydro-acoustic oscillator are selected, depending on the flow velocity in the pipe, to create resonance. The remaining dimensions are empirical, and it was found to be possible to minimize the amount of fluid required to feed the nozzle, while maximizing the amount of energy that can be extracted from cavitation bubbles.

For the present invention, one must assume the following relationships for estimating various nozzle parameters:

To calculate the flow rate through the nozzle the following relationship can be used:

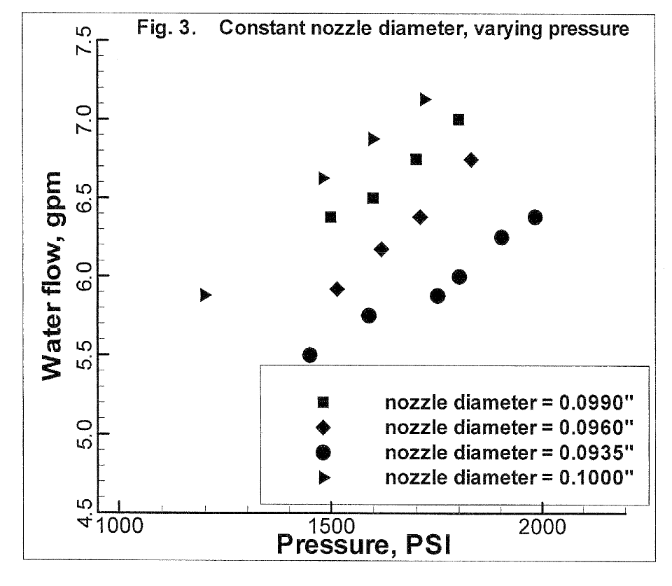

Q=k\sqrt{P}D² (1)

where Q—flow rate (gallons per minute), P—pressure (psi), D—nozzle orifice (in inches). The coefficient k is determined empirically by fitting equation (1) into the data shown in FIG. 3. Various nozzle configurations, including all three configurations shown on FIGS. 1a-c, were tested.

Coefficient k≈23.8 for tested nozzle configuration shown in FIG. 1c, k≈21.3 for the tested nozzle configuration shown in FIGS. 1b and k≈16.8 for the tested nozzle in FIG. 1a. The coefficient, however, can vary depending on nozzle configuration and size. It was found that the nozzle shown in FIG. 1a produces more agressively cavitating flow and requires smaller amounts of fluid to operate than the nozzles shown in FIGS. 1b and 1c.

The diameter of the orifice (3)—Dₒ is usually selected based upon the available information about the inflow conditions (pressure in the supply and the flow rate available). The orifice should be sufficiently large to accommodate the required amount of fluid to flow through it. The diameter of the oscillator (2)—Dₚ should be at least three times larger than Dₒ, and preferably at least four to six times larger. The length of the oscillator is selected to accommodate resonance condition in the chamber (2). It is possible to create a standing wave in the oscillator with the wavelength

$$l = 2 \frac{{L}_{p}}{n}$$

and the frequency

$$f = \frac{cn}{2 {L}_{p}}$$

(where c is the speed of sound and n is the mode). Lₚ can be selected to be

$${L}_{p} = \frac{{cD}_{o}}{2 {SV}_{j}} ,$$

where Vⱼ is the velocity of the jet and can be found from the flow rate Q and diameter Dₒ and S is a Strouhal number, which is a dimensionless parameter that describes a vortex flow (flow through the obstructions). The Strouhal number that produces unsteady flow can be taken to be equal to about 0.2.

Dimensions L_{c}, Lₛ, Lₒ in the tests performed were selected to be comparable for the diameter of the orifice Dₒ. The tests performed were based on the following sizes Lₛ=Lₒ=0.5 L_{c}=Dₒ. Diameter and angle of the diffuser were selected based on experiments, and various nozzle configurations were tested with angle θ varying from 30° to 100°. The best results were found for θ=80° The values for the diameter of the oscillator range from 2 to 10 times the diameter of the orifice Dₒ.

The energy imparted to the liquid by the collapse of cavitation bubbles emerging from the nozzle can be used to impart heat to the liquid.

The cavitation nozzle of the present invention can also be used to clean submerged structures, such as bridge piers and pilings, petroleum drilling and production platform jackets and legs, and marine pier pilings, as well as the submerged parts of vessels.

The cavitation nozzle of the present invention can be used to clean almost any type of surface, including but not limited to steel and ferrous metals, non-ferrous metals and alloys, fiberglass, concrete, plastics, rubber, wood and other composite materials.

The cavitation nozzle of the present invention is superior to conventional nozzles that use high water pressure because the high energy cavitation stream delivers more energy than conventional nozzles. For example, the high energy cavitation nozzles of the present invention can be used for cleaning surfaces, such as ship's hulls, rudders, propellers, and kingstons, to remove biological growth on the surface and destroy the microorganisms with one pass of the cleaning tool. This makes it possible to avoid the use of poisonous compounds and paints to prevent biological growth on ships' hulls and bottoms, as this growth can be easily removed with one pass of the nozzle over a ship's surface.

The cavitation nozzle of the present invention can be used in any situation in which a stream of high energy fluid is needed. Films can be removed from surfaces such as the surfaces of hydraulic engineering structures, including hydroelectric power stations, coastal structures, underwater nets, sea platforms for gas and oil recovery, offshore platforms, turbine blades, sewage tanks, pipes, etc.

The cavitation nozzle of the present invention produces a high energy stream of cavitation bubbles that can be used for demolition of materials such as concrete, or for cleaning biological or chemical matter from surfaces. In addition to cleaning the biological material, the cavitation nozzle of the present invention disrupts cell membranes so that biological materials are destroyed by the high energy produced.

The high energy cavitation bubbles produced by the cavitation nozzle of the present invention can be used to disperse and sterilize liquids, as well as combining polar and non-polar fluids into a high quality emulsion.

Additionally, because of the great amount of heat generated by the collapsing bubbles, the nozzle of the present invention can be used to heat water or other fluids.

The cavitation nozzle of the present invention can be used to clean man-made water reservoirs, including but not limited to swimming pools, pre-stressed concrete water tanks, or any other type of surface. These types of surfaces include but are not limited to gunite, marsite, concrete, fiberglass, and plastic.

The cavitation nozzle of the present invention can also be used to clean the interiors of pipes, tubing, tanks, and pressure vessels.

The cavitation nozzle of the present invention is also well suited to sanitary applications, including but not limited to destruction of black algae and other microorganisms in swimming pools and other reservoirs. As noted above, the heat and pressure generated by the cavitation nozzle of the present invention can be used to disinfect potable water as well as swimming pool water. The cavitation nozzle of the present invention can be used to destroy microorganisms and other living creatures the same size or smaller than the cavitation bubbles in bilge water on ships and boats. Likewise, the cavitation nozzle of the present invention generates heat or pressure from the bubbles' collapsing, which can be used to disinfect waste water and sewage. The force of the cavitation nozzle of the present invention is such that the nozzle can be used to cut concrete or other hard materials under water.

A wide variety of liquids and water sources may be contaminated with various organic wastes and/or dissolved organic compounds. Decontamination systems using the nozzle of the present invention will be advantageous in remediating such liquids and water sources. In addition to eliminating dissolved contaminants, as described above, the nozzle can also eliminate undesirable microorganisms (including algae, both unicellular and multicellular, bacteria, fungi, protozoa, and viruses) as well as their larvae. Pathogenic microorganisms, including, but not limited to, bacteria such as E. coli and salmonella, both of which cause gastrointestinal illness, are a source of contamination to be eliminated from municipal water supplies, private wells, and other waters. Remediation may be desired to eliminate algae, fungi, protozoa, or viruses in many different types of settings. Solutions containing any of these microorganisms can be subjected to the fluid jet cavitation produced by the nozzle of the present invention, resulting in their destruction and decomposition.

Other organisms may be vulnerable to treatment by the present cavitation process when present in their larval form. For example, zebra mussels, small, fingernail-sized, fresh-water mollusks accidentally introduced to North America, have spread rapidly throughout the Great Lakes Mississippi River basin, and other inland waterways in the United States and Canada. A major nuisance, zebra mussels have colonized water supply pipes of hydroelectric and nuclear power plants, public water supply plants, and industrial facilities, in many cases dangerously restricting water intake to heat exchanges, cooling systems and the like. Although the adult mussel would not be affected, the larval form is free-swimming and susceptible to destruction by fluid jet cavitation such as provided by the nozzle of the present invention. Thus, the nozzle of the present invention can be used to treat large columns of water in which zebra mussels are a problem, to eliminate significant larval populations before they colonize additional surfaces. This method can be similarly applied to larval forms of other pests which may be present in water.

Contaminated liquid, such as aqueous solutions or water from a variety of sources, can be remediated using the nozzle of the present invention by passing at least a portion of the contaminated liquid through at least one nozzle of the present invention to induce fluid jet cavitation in that liquid, wherein the fluid jet cavitation is sufficiently intense to cause decomposition or destruction of contaminants in the liquid. The decomposition or destruction is the result of oxidation, reduction, heating, or mechanical rupture, or any combinations thereof. The contaminants can be organic compounds, oxidizable inorganic compounds, reducible inorganic compounds, microorganisms, and larvae.

In addition to the applications for the nozzle of the present invention noted above, there are many other applications for the nozzle. For example, systems and apparatus incorporating the nozzle of the present invention can be adapted to the full range of municipal and industrial settings, including, but not limited to, treatment of navigable waters, sanitary systems and industrial effluent. In addition, smaller systems and units will be suitable for the remediation needs of smaller-scale applications, including, but not limited to, the treatment of private wells and pools, prevention of disease and system upset in aquaculture and aquarium environments, and the like.

It has also been found that controlling the liquid and cavitation environment can further increase oxidation efficiency. The temperature and pH of the liquid to be treated can be controlled to increase the efficiency of the decontamination. In addition, treating the liquid by entraining or saturating with various gases, preferably prior to cavitation, can be employed to further improve the rate of decontamination. Any convenient means may be used, including bubbling the gas through a liquid.

It is to be understood that the phraseology or terminology employed herein is for the purpose of description and not of limitation. The means and materials for carrying out disclosed functions may take a variety of alternative forms without departing from the invention. Thus, the expressions “means to . . . ” and “means for . . . ” as may be found the specification above, and/or in the claims below, followed by a functional statement, are intended to define and cover whatever structural, physical, chemical, or electrical element or structures which may now or in the future exist for carrying out the recited function, whether or not precisely equivalent to the embodiment or embodiments disclosed in the specification above, and it is intended that such expressions be given their broadest interpretation.

What is claimed is:

1. A method for producing cavitation in a fluid comprising:
(a) introducing liquid into a hydro-acoustic oscillator, wherein said hydro acoustic oscillator is connected to an orifice which is connected to a diffuser, whereby the hydro-acoustic oscillator introduces pressure fluctuation into the liquid to stimulate cavitation generation;
(b) introducing the liquid into the orifice, wherein the diameter of the hydro-acoustic oscillator is at least three times the diameter of the orifice, whereby the velocity of the liquid flow is increased, creating low pressure conditions;
(c) injecting the fluid into the diffuser, said diffuser comprising three zones;
(i) the first zone of the diffuser diffuses the liquid;
(ii) the second zone of the diffuser comprises shear chambers that create a rotational (vertical) flow in the chambers;
(iii) the third zone of the diffuser wherein vortices are created from shear stress between the jet flow and ambient fluid into which the jet is introduced;
(d) whereby the jet has a higher speed and a lower pressure than the pressure of the fluid into which the jet is directed, causing flow in the direction of high to low pressure, further increasing shear stress.

2. The method according to claim 1 wherein the diameter of the hydro-acoustic oscillator is at least six times the diameter of the orifice.

3. A method for heating liquid comprising producing cavitation in a fluid comprising:
(a) introducing liquid into a hydro-acoustic oscillator, wherein said hydro acoustic oscillator is connected to an orifice which is connected to a diffuser, whereby the hydro-acoustic oscillator introduces pressure fluctuation into the liquid to stimulate cavitation generation;
(b) introducing the liquid into the orifice, wherein the diameter of the hydro-acoustic oscillator is at least three times the diameter of the orifice, whereby the velocity of the liquid flow is increased, creating low pressure conditions;
(c) injecting the fluid into the diffuser, said diffuser comprising three zones;
(i) the first zone of the diffuser diffuses the liquid;
(ii) the second zone of the diffuser comprises shear chambers that create a rotational (vertical) flow in the chambers;
(iii) the third zone of the diffuser wherein vortices are created from shear stress between the jet flow and ambient fluid into which the jet is introduced;
(d) whereby the jet has a high speed and a lower pressure than the pressure of the fluid into which the jet is directed, causing flow in the direction of high to low pressure, further increasing shear stress.

4. The method according to claim 3 wherein the heat created in the fluid is used to sanitize water.

5. A method for cleaning surfaces comprising producing cavitation in a fluid comprising:
(a) introducing liquid into a hydro-acoustic oscillator, wherein said hydro acoustic oscillator is connected to an orifice which is connected to a diffuser, whereby the hydro-acoustic oscillator introduces pressure fluctuation into the liquid to stimulate cavitation generation;
(b) introducing the liquid into the orifice, wherein the diameter of the hydro-acoustic oscillator is at least three times the diameter of the orifice, whereby the velocity of the liquid flow is increased, creating low pressure conditions;
(c) injecting the fluid into the diffuser, said diffuser comprising three zones;
(i) the first zone of the diffuser diffuses the liquid;
(ii) the second zone of the diffuser comprises shear chambers that create a rotational (vertical) flow in the chambers;
(iii) the third zone of the diffuser wherein vortices are created from shear stress between the jet flow and ambient fluid into which the jet is introduced;
whereby the jet has a high speed and a Tower pressure than the pressure of the fluid into which the jet is directed. Causing flow in the direction of high to low pressure, further increasing shear stress.

6. The method according to claim 5 wherein the surface is selected from the group consisting of steel and other ferrous metals, non-ferrous metals and alloys, fiberglass, concrete, plastic, rubber, and wood.

7. A method for remediating contaminated liquid comprising producing cavitation in the liquid comprising:
(a) introducing the contaminated liquid into a hydro-acoustic oscillator, wherein said hydro acoustic oscillator is connected to an orifice which is connected to a diffuser, whereby the hydro-acoustic oscillator introduces pressure fluctuation into the liquid to stimulate cavitation generation;
(b) introducing the liquid into the orifice, wherein the diameter of the hydro-acoustic oscillator is at least three times the diameter of the orifice, whereby the velocity of the liquid flow is increased, creating low pressure conditions;
(c) injecting the fluid into the diffuser, said diffuser comprising three zones;
(i) the first zone of the diffuser diffuses the liquid;
(ii) the second zone of the diffuser comprises shear chambers that create a rotational (vertical) flow in the chambers;
(iii) the third zone of the diffuser wherein vortices are created from shear stress between the jet flow and ambient fluid into which the jet is introduced;
whereby the jet has a high speed and a lower pressure than the pressure of the fluid into which the jet is directed. Causing flow in the direction of high to low pressure, further increasing shear stress.

8. The method according to claim 7 wherein the contaminants are decomposed or destroyed as a result of oxidation, reduction, heating or mechanical rupture, or combinations thereof.

9. The method according to claim 8 wherein the fluid is contaminated with at least one of organic contaminants, utilizable inorganic compounds, reducible inorganic compounds, microorganisms, and larvae.
